(19) United States
(12) Patent Application Publication
(10) Pub. No.: US 2002/0089139 A1
(43) Pub. Date: Jul. 11, 2002

(54) Scooter steering control

(76) Inventors: Timothy C. Reynolds, Los Angeles, CA (US); Keyvan T. Diba, Los Angeles, CA (US)

Correspondence Address: Thomas M. Small, Small Larkin, LLP, 18th Floor, 10940 Wilshire Boulevard, Los Angeles, CA, 90024, US

(21) Appl. No.: 10/038,966

(22) Filed: Jan. 3, 2002

Related U.S. Application Data
(60) Provisional application No. 60/256,726, filed on Jan. 5, 2001.

(51) Int. Cl. B62M 1/00

(52) U.S. Cl. 280/87.041

(57) ABSTRACT

A scooter steering control on small-wheeled scooter having a steerable front wheel on a handlebar, the control comprising two split sleeves fitted around the handlebar and the mounting tube on the scooter body, and a control pin slidable on the upper sleeve into and out of a recess on the lower sleeve. The recess has angularly spaced sidewalls forming stops for limiting turning of the front wheel. A spring-loaded latch holds the pin releasably in engaged and disengaged positions, and a second spring urges the pin toward the disengaged position.

### REFERENCE TO PRIOR PROVISIONAL APPLICATION

This application claims the benefit of prior copending provisional application No. 60/256,726, filed Jan. 5, 2001.

### BACKGROUND OF THE INVENTION

This invention relates to a safety device for small-wheeled vehicles, and relates more particularly to a safety steering control for the steerable wheel of a vehicle such as a scooter.

The current popularity of small-wheeled scooters such as the popular “RAZOR” brand of scooters has been accompanied by a substantial increase in the number of injuries resulting from accidents of various types. One type, in particular, is the so-called “jack-knifing” of the scooter when it is operating at high speed and, for various reasons, the front wheel is turned more sharply than the scooter can accommodate.

When the forward momentum of the scooter is very high, it may continue forwardly instead of turning with the wheel, and crimp the front wheel in a non-rotating, turned position, typically causing the scooter and its user to crash. At a lower level of excessive speed, this sometimes causes the occupant simply to lose steering control, sometimes with similar disastrous results.

### SUMMARY OF THE INVENTION

The present invention resides in a steering control for the steerable wheels of scooters and other small-wheeled vehicles, which is adapted for easy installation on conventional scooters and, when installed, is selectively engageable to provide safety control by limiting the angular steering motion of the front wheel to a restricted range that is much less likely to result in jack-knifing or other steering accidents. The control can be engaged in a quick and easy manner, and can be disengaged with equal ease so as to avoid interference with the full range of steering during lowspeed operation.

For these purposes, the preferred embodiment of the invention comprises two relatively movable control elements for mounting on the support for the steerable wheel, typically the handlebar, and on the body of the scooter, and a selectively engageable and disengageable, motion-limiting coupling between the control elements that is operable, when engaged, to restrict relative turning of the elements, and thus of the handlebar, relative to the body, and limit such turning to the selected range. The control elements may be attachments that are installed as “aftermarket” add-ons, or may be built into the scooter by the manufacturer as “OEM” equipment.

More specifically, the preferred embodiment of the invention, shown in the drawings for purposes of illustrating the invention, comprises upper and lower attachments that are mounted, respectively, on the handlebar and on the body. These attachments are on the turnable handlebar post above the mounting tube on the front of the body, supporting the handlebar rotatably on the body, and on the mounting sleeve itself. These attachments are preferably tubular sleeves, each of which is longitudinally split or divided on one side for ease of mounting on the post and the mounting sleeve, and each preferably having a snap-locking, channel-shaped “keeper” that fits over outwardly extending ribs along the splits to hold the attachments securely in place. Both of the attachments and keepers may be relatively hard plastic such as polypropylene.

The motion-limiting coupling between the two attachments is formed by angularly spaced abutments on one of the attachments, herein opposite ends of a limiting recess in the lower one and a control member in the form of a pin mounted on the other attachment, preferably the upper one, to move longitudinally of the handlebar post into and out of the limiting recess. Conveniently, the attachment having the recess is positioned behind the handlebar mounting sleeve with the two abutments spaced equally to each side, and the control pin is positioned immediately behind the handlebar post and is centered in the recess in the straight-ahead steering position of the front wheel.

A selectively operable latch is provided to hold the control pin selectively in a raised, disengaged position and in a lowered, engaged position in which the lower end of the pin is in the recess. An optional second, wider recess may be provided above the first recess to provide a second, less limited steering range, the control pin being movable between two different engaged positions as well as a disengaged position. Another alternative embodiment forms the motion-limiting recess as a flexible rubber 0-ring that is trapped in place in the lower attachment, thereby softening the limiting action of the steering control.

Other features and advantages of the invention will become apparent from the accompanying drawings.

### BRIEF DESCRIPTION OF THE DRAWINGS

FIG. 1 is a perspective view of a representative scooter on which the present invention may be used;

FIG. 2 is an enlarged fragmentary side elevational view of the front portion of the scooter of FIG. 1, with a steering control in accordance with the present invention installed on the scooter;

FIG. 3 is a further enlarged cross-sectional view taken along line 3-3 of FIG. 2;

FIG. 4 is an enlarged cross-sectional view taken substantially along line 4-4 of FIG. 2 with turned positions of the parts shown in broken lines;

FIG. 4a is a fragmentary perspective view showing portions of an alternative embodiment of the lower control element;

FIG. 5 is an enlarged fragmentary side elevational view of the control elements of the first embodiment, taken from the direction indicated by the arrows 5-5 in FIG. 2; and

FIG. 6 is an enlarged partial cross-sectional view taken substantially along line 6-6 of FIG. 3.

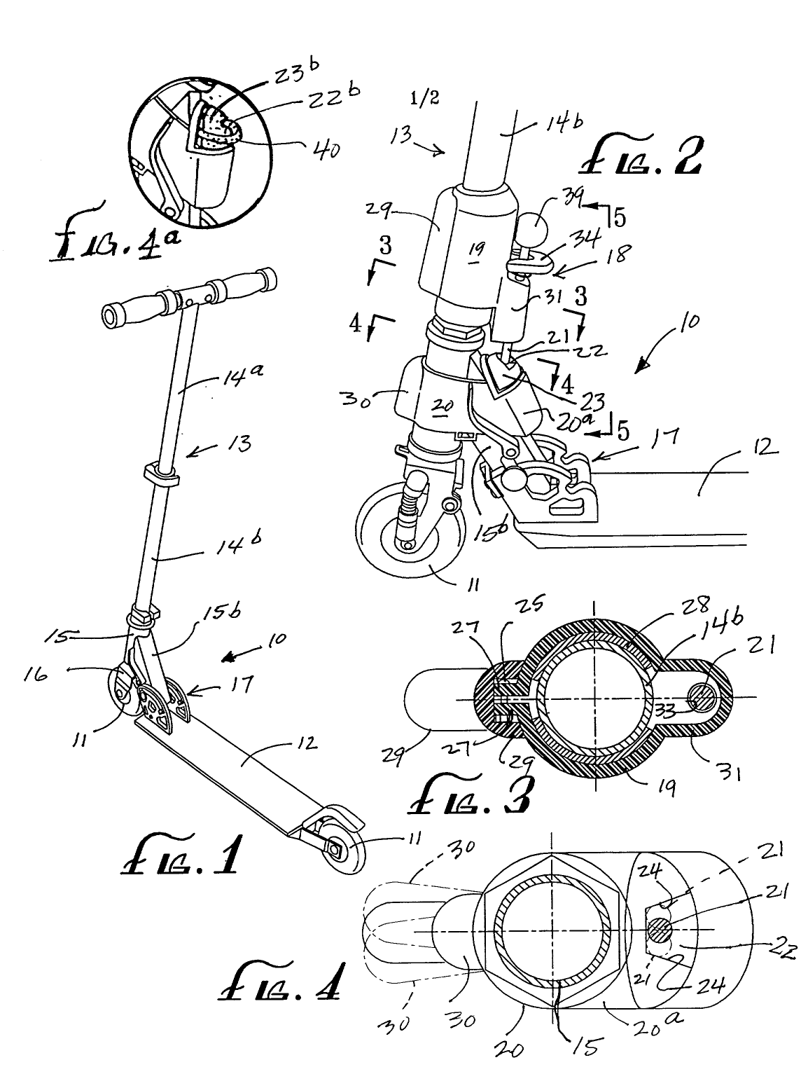

### DETAILED DESCRIPTION

Shown in the drawings for purposes of illustration is a conventional small-wheeled vehicle 10, specifically a scooter of the type sold under the “RAZOR” brand having small front and rear wheels 11 rotatably mounted on a body 12 forming the footrest of the scooter, and a steerable handlebar on the front end, indicated generally by the reference number 13. The handlebar has a conventional T-shaped upper portion with a depending post 14a that is telescoped into a tubular lower portion 14b permitting adjustment of the effective height of the handlebar.

The lower portion 14b of the handlebar post extends rotatably through a tubular mounting sleeve 15 supported on the front end of the scooter body 12 by an inclined front support 15b, and carries a wheel bracket or fork 16 on its lower end, rotatably mounting the front wheel 11. This wheel thus is steerable by turning the handlebar 13 in the mounting sleeve 15. A conventional folding hinge 17 is shown as the connection between the body 12 and the support 15b for the mounting sleeve 15, but this could be a non-folding connection as well.

In accordance with the present invention, a steering control, indicated generally by the reference number 18 in FIG. 2, is provided between the handlebar 13 and body 12, preferably at the handlebar mounting sleeve 15 which is fixed relative to the body. The steering control is selectively engageable to provide a motion-limiting safety control for the front wheel 11 of the scooter so that it cannot be turned, either intentionally or inadvertently, farther from the straight-ahead position than a preselected maximum amount in either direction. Moreover, the control can be disengaged quickly and easily so as to avoid interference with the full range of steering that sometimes is desirable, particularly during low-speed operation.

More specifically, and as shown in the first embodiment of the invention shown in FIGS. 2, 3, 4, 5 and 6, the steering control 18 comprises first and second control elements in the form of split sleeves 19 and 20 that are mounted respectively on the handlebar 13 and on the handlebar mounting sleeve 15 for relative rotation during turning of the steerable front wheel 11, and a motion-limiting coupling in the form of a control pin 21 that is slidably mounted on the upper control element 19 and has a depending free lower end that extends out of the upper element toward the lower element 20. Formed in the lower element is a control opening 22 that is angularly aligned with the pin when the front wheel 11 is in the straight-ahead position, and which receives the lower end portion of the pin when the latter is extended downwardly into an engaged position. This position is shown in the drawings.

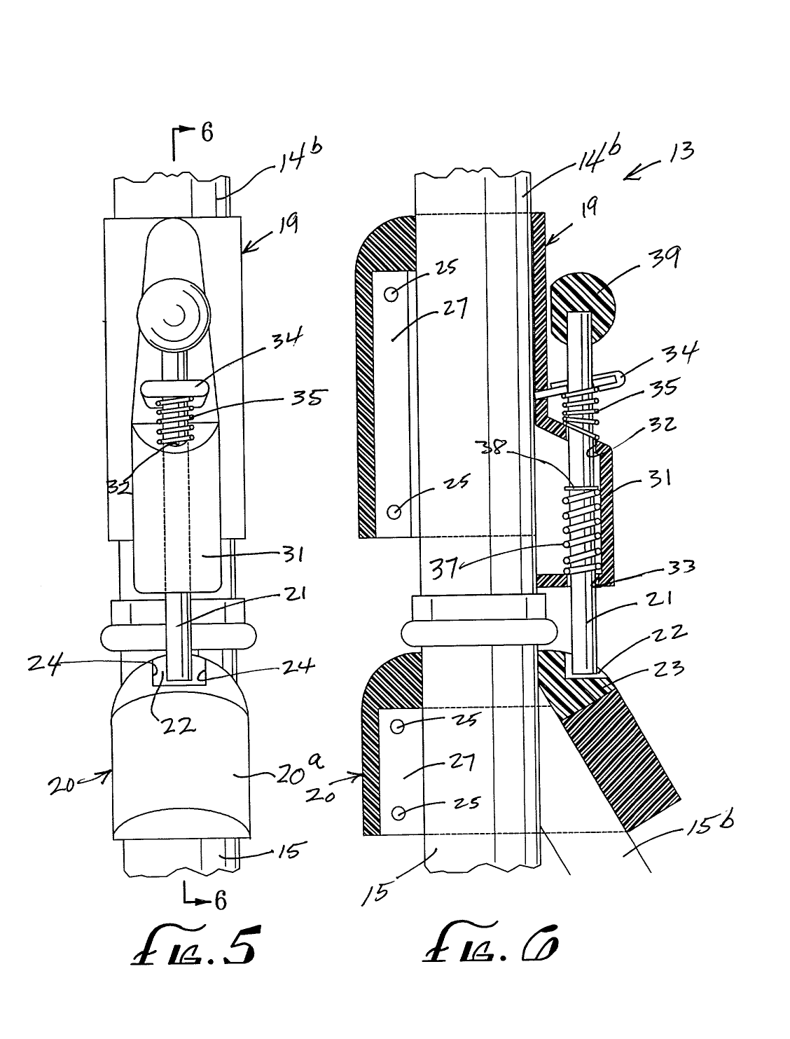

In the illustrative embodiment, the control opening 22 is a recess in the upper side of an upward extension 23 of the lower control element 20, and has laterally spaced sidewalls 24 that are disposed on opposite sides of the extended control pin, and an open rear side. It can be seen in FIG. 4 that the sidewalls diverge toward the rear of the scooter 10, in planes generally lying on radii of the handlebar 13. Accordingly, as the handlebar turns the wheel in each direction, one of these sidewalls comes into flat engagement with the control pin 21 in the recess 22.

In the presently preferred embodiment shown in FIGS. 2 through 6, the split sleeves 19 and 20 of the control elements are fitted around the lower handlebar post 14b and the mounting tube 15, respectively, and are clamped tightly in place by nut-and-bolt fasteners 25 (see FIG.3) in two longitudinal ribs 27 on the front side of each sleeve, along the longitudinal split therein. A spacer 28 is provided in each of the sleeves 19, 20 to be clamped by the sleeve against the tubular part on which it is mounted, for firm gripping engagement, and a channel-shaped cover 29, 30 is fitted over each pair of ribs 27 to provide a streamlined, finished look.

As shown most clearly in FIGS. 5 and 6, the control pin 21 is mounted on a hollow housing 31 that is formed integrally as part of the upper sleeve 19, on its rear side opposite the ribs 27, and is slidable up and down in two aligned mounting holes 32 and 33 in the top and bottom walls of the housing. A slide latch 34 is pivotably mounted on the sleeve 19, above the housing 31, to hold the pin 21 releasably in different selected positions, the “engaged” position being shown in FIG. 6, and two coiled compression springs 35 and 37 are fitted around the control pin. One of these is disposed outside the housing between the top wall and the slide latch 34 to urge the latch upwardly into a “latched” condition, binding on and holding the pin 21. The other spring 37 is disposed inside the housing 31 and compressed between the bottom wall and a collar 38 on the pin, to urge the pin upwardly relative to the housing. With this arrangement, the latch 34 normally holds the pin stationary, whether engaged or disengaged, and when depressed, will release the pin for movement to the disengaged position by the spring 37. The control pin thus can be engaged simply by pushing down on a knob 39 on its upper end with sufficient force to overcome the holding power of the spring-loaded latch.

The lower sleeve 20 has a rearward extension 20 that passes from the mounting tube 15 around the inclined mounting bar 15b that carries the mounting sleeve in the illustrative scooter, and the motion-limiting recess 22 is secured to the upper side of the sleeve behind the mounting tube. As viewed in FIGS. 2 and 4, it can be seen that the stop member herein is a separate piece set into a notch in the top of the sleeve. It will be evident, however, that the recess may be formed in an integral rearward extension of the sleeve (not shown).

An alternative embodiment of the stop member is shown in FIG. 4a as an insert 23b that defines a stop recess 22b within a closed loop 40 of flexible material such as plastic that yields to a limited extent when engaged by the control pin 21. This provides a softened stop action, as compared to the abrupt stop action of the first embodiment. In all other respects, the alternative embodiment may be the same as the first embodiment.

From the foregoing, it will be seen that the present invention provides a simple, practical and effective steering control for scooters and other small-wheeled vehicles that can be installed as an after-market accessory or built into the vehicle as an item of original equipment. It also will be evidence that, while specific embodiments have been illustrated and described, various modifications and changes may be made without departing from the spirit and scope of the invention.

We claim as our invention:

1. A safety steering control for a small-wheeled vehicle having a body and a handlebar rotatably mounted on the body, said control comprising:
first and second control elements mountable respectively on said handlebar and said body for relative angular motion as the handlebar turns;
a motion-limiting member mounted on one of said elements and having a recess therein with walls forming angularly spaced stops;
a control pin mounted on the other of said elements and movable thereon between an engaged position with a portion of said pin on said recess between said stops, and a disengaged position with said portion removed from between said stops;
and latch means for holding the control pin releasably in the engaged position and in the disengaged position;
said stops being spaced a preselected angular distance apart to limit turning of the control pin, and thus of the handlebar, when the pin is in the engaged position.

2. A steering control as defined in claim 1 wherein said vehicle is of the type having a mounting a tube on the body for rotatably supporting the handlebar, and said elements are longitudinally split sleeves adapted to be fitted over and secured to the handlebar and the mounting tube.

3. A steering control as defined in claim 2 wherein the motion-limiting member is mountable on the mounting tube and has a recess with angularly spaced walls forming said stops.

4. A steering control as defined in claim 3 wherein the recess in the motion limiting member is defined by a flexible loop secured to the member, thereby providing for softened stop action.

5. A steering control as defined in claim 2 wherein said latch means comprise a slide latch for frictionally clamping the control pin in a selected position, and a latch spring urging the latch yieldably toward the latched position.

6. A steering control as definded in claim 5 further including a second spring urging said pin toward the unlatched position, whereby the control is disengaged by releasing said latch.

7. A safety steering control or a small-wheeled vehicle having a body and a steerable member rotatably mounted on said body, said control comprising:
first and second control elements mountable respectively on said steerable member and on said body for relative angular motion as the steerable member turns;
a motion-limiting member mounted on one of said elements and having angularly spaced stops;
a control member mounted on the other of said elements and movable thereon between on engaged position between said stops and a disengaged position spaced away from said engaged position;
and means for releasably holding the control member on the engaged position and on the disengaged position.
